(19) United States
(12) Patent Application Publication
(10) Pub. No.: US 2008/0083513 A1
(43) Pub. Date: Apr. 10, 2008

(54) Dual-purpose fixing core for a blind

(75) Inventor: Dong Rong Chen, Taichung (TW)

Correspondence Address: BRUCE H. TROXELL, SUITE 1404, 5205 LEESBURG PIKE, FALLS CHURCH, VA, 22041, US

(73) Assignee: Nien Made Enterprise Co., Ltd.

(21) Appl. No.: 11/518,418

(22) Filed: Sep. 11, 2006

(51) Int. Cl. E06B 9/307

(52) U.S. Cl. 160/177 R

(57) ABSTRACT

A dual-purpose fixing core for a blind includes a core rod secured in the interior and axially bored with a central shaft hole. The fixing core is axially formed inside with an accommodating chamber above the core rod. The accommodating chamber has at least one side formed with an opening and has its upper side formed with a top wall axially bored with two parallel elongated slots for the ladder strap or the ladder cord of a blind to pass therethrough. The fixing core is provided with an upright plate extending outward diametrically from the outer circumferential side of the core rod to the top wall between the two elongated slots. Thus, the ladder straps or the ladder cords of a blind can be optionally fixed with in the two elongated slots, facilitating assembly of the ladder straps or ladder cords and reducing the producing cost of the fixing cores.

### BACKGROUND OF THE INVENTION

1. Field of the Invention

This invention relates to a dual-purpose fixing core for a blind, particularly to one applicable to different kinds of blinds linked by ladder cords or by ladder straps.

2. Description of the Prior Art

A conventional blind generally has the opposite sides of its slats respectively linked by a ladder cord or by a ladder strap fitted with a fixing core assembled at the opposite sides of the upper rail of the blind. The fixing cores of the blind can be controlled by a rotating shaft to turn for a preset angle and actuate the ladder cords or the ladder straps and the slats of the blind to move bias for a preset angle. One kind of the conventional blinds has its fixing core 1 provided with only one kind of ladder cord slot or ladder strap slot, as disclosed in a U.S. Pat. No. 6,189,596 B1, which was designed by the inventor of this invention and in which the fixing core is only for a ladder cord to be fitted thereon. Another kind of the conventional blinds has its fixing core bored with two kinds of fixing slots: a ladder fixing slot for fixing ladder straps and a ladder cord fixing slot for fixing ladder cords of the blind.

However, if the fixing core of the conventional blind is provided with only one kind of ladder cord slot or ladder strap slot, this single kind of fixing slot cannot receive both ladder cords and ladder straps at the same time because a ladder cord and a ladder strap are different in structure and their fixing slots are different in shape. In this case, if a blind linked by different kinds of ladder cords or ladder straps is to be assembled, two different kinds of fixing cores with different-shaped fixing slots must be prepared. On the other hand, if the fixing core of the conventional blind is bored with two different kinds of fixing slots to be optionally chosen for fixing a ladder strap or a ladder cord according to practical needs, it will complicate the process of producing the fixing cores and increase producing coat for making another kind of fixing slot.

### SUMMARY OF THE INVENTION

The objective of the invention is to offer a dual-purpose fixing core for a blind, which includes a lengthwise core rod secured in the center and axially bored with a central shaft hole. The fixing core is formed in the interior with an accommodating chamber preset in size above the core rod. The accommodating chamber of the fixing core has at least one side formed with an opening, and its upper side formed with a top wall axially bored with two elongated slots respectively having a width large enough for the ladder strap or the ladder core of a blind to pass therethrough. The accommodating chamber of the fixing core is further disposed with an upright plate extending outward diametrically from the outer circumferential side of the core rod to the top wall between the two elongated slots. By so designing, different kinds of ladder straps or ladder cords can be optionally fixed in the two elongated slots of the fixing core for controlling the slats of the blind, enabling the ladder straps or ladder cords of a blind to be assembled on the fixing cores quickly and accurately and reducing the producing cost of fixing cores.

### BRIEF DESCRIPTION OF DRAWINGS

This invention will be better understood by referring to the accompanying drawings, wherein:

FIG. 1 is a perspective view of dual-purpose fixing core for a blind in the present invention;

FIG. 2 is a side cross-sectional view of the dual-purpose fixing core for a blind in the present invention;

FIG. 3 is an upper view of the dual-purpose fixing core for a blind in the present invention;

FIG. 4 is a perspective view of the dual-purpose fixing core fitted thereon with ladder straps in the present invention;

FIG. 5 is a side cross-sectional view of the dual-purpose fixing core fitted thereon with ladder straps in the present invention; and

FIG. 6 is a perspective view of the dual-purpose fixing core fitted thereon with ladder cords in the present invention.

### DETAILED DESCRIPTION OF THE PREFERRED EMBODIMENT

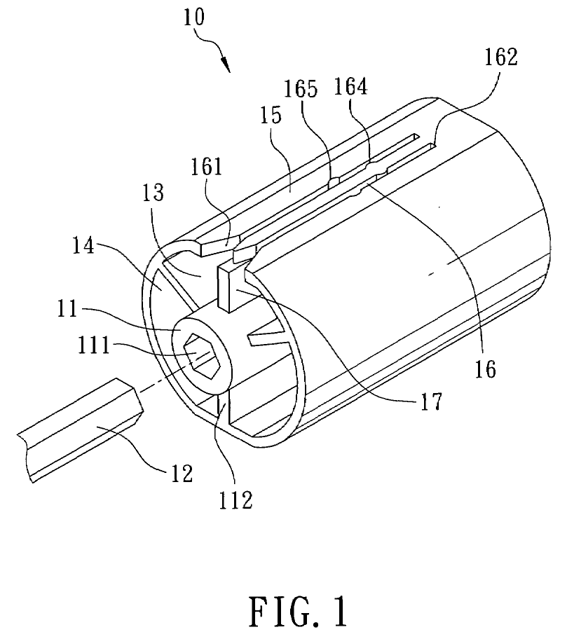

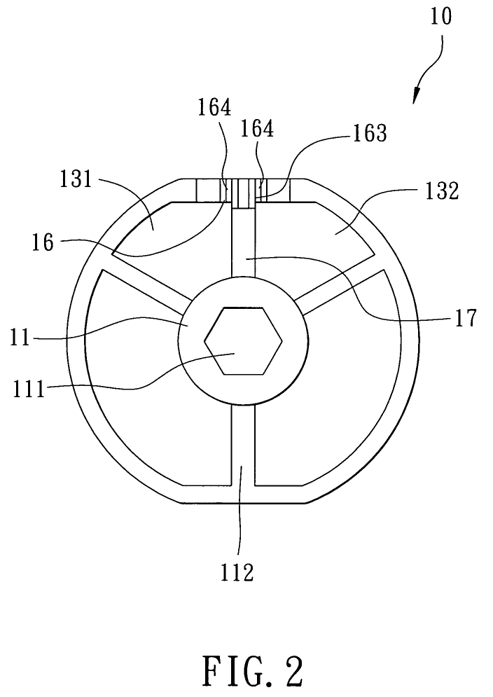

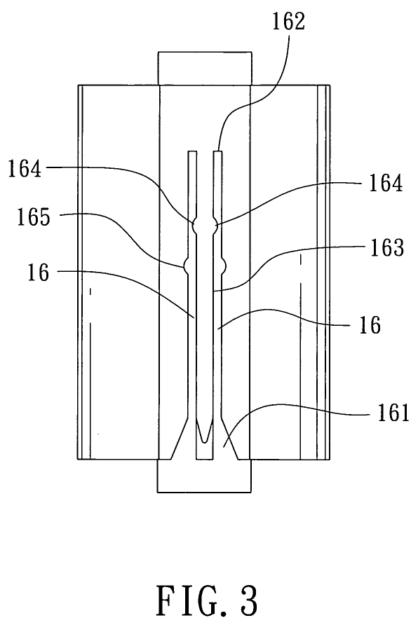

A preferred embodiment of a dual-purpose fixing core 10 to be pivotally assembled with the fixing holder on the upper rail of a blind for fixing the ladder strap 20 or the ladder cord 30 of the blind in the present invention, as shown in FIGS. 1, 2 and 3, includes a core rod 11 axially secured at a preset location in the interior. The core rod 11 is axially bored with a shaft hole 111 in the center interior for a shaft 12 to be inserted therein so that, when the shaft 12 is rotated, the fixing core 10 and the blind connected with the fixing core 10 can be actuated to move bias for a preset angle.

Further, the fixing core 10 is axially bored inside with at least one accommodating chamber 13 preset in size along the outer side of the core rod 11. The accommodating chamber 13 of the fixing core 10 has at least one side formed with an opening 14. In this preferred embodiment, the fixing core 10 has its opposite sides respectively formed with an opening 14. Furthermore, the accommodating chamber 13 of the fixing core 10 has its upper circumferential side formed with a top wall 15 bored axially with two parallel elongated slots 16 having a length approximately equivalent to the width of a ladder strap 20. Each elongated slot 16 has a width large enough for a ladder strap 20 or a ladder cord 30 to pass therethrough but smaller than the width of the accommodating chamber 13. Further, each elongated slot 16 has one end near the front end opening 14 of the accommodating chamber 13 formed with a gradually-expanded open end 161 with an opening a little larger than the width of the elongated slot 16, and the other end formed with a closed end 162. Each elongated slot 16 has at least one inner wall 163 provided with at least one position-limiting projection 164 or one position-limiting notch 165. In this preferred embodiment, each elongated slot 16 has its opposite inner walls respectively provided with a position-limiting projection 164 and a position-limiting notch 165.

In addition, the accommodating chamber 13 is fixed in the interior with an upright plate 17 extending outward diametrically from the outer circumferential side of the core rod 11 to the upper wall 15 between the two elongated slots 16 to separate the accommodating chamber 13 into a first accommodating chamber 131 and a second accommodating chamber 132 respectively aligned to one of the two elongated slots 16. Moreover, the accommodating chamber 13 of the fixing core 10 is also fixed inside with ribs 112 preset in number spaced apart and extending outward diametrically from the outer circumferential side of the core rod 11 to the circumferential wall of the fixing core 10. The rib 112 positioned at a preset location in the first and the second accommodating chamber 131, 132 at the opposite sides of the upright plate 17 respectively formed with an included angle within 120 degrees. In this preferred embodiment, the fixing core 10 is provided with three ribs 112 spaced apart equidistantly and respectively formed with an included angle of 120 degrees.

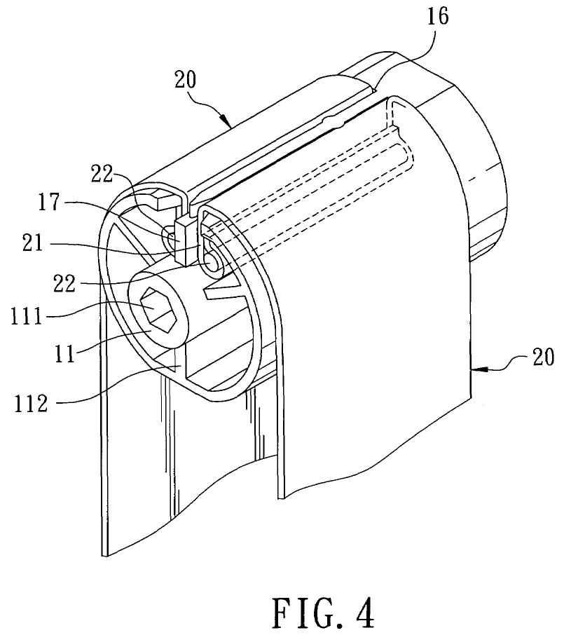

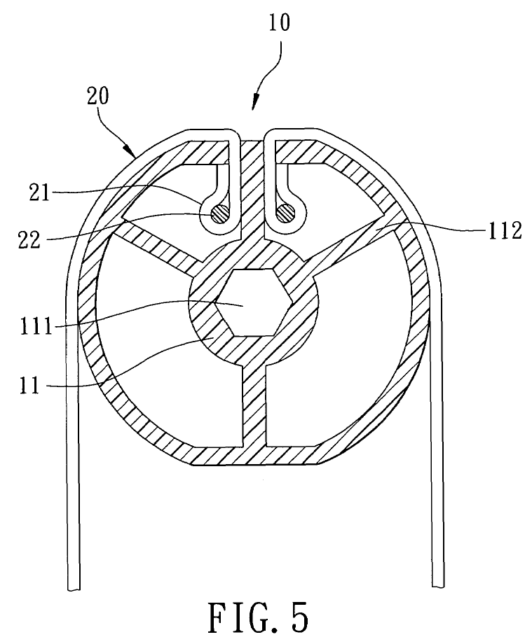

To assemble two ladder straps 20 on the fixing core 10, as shown in FIGS. 4 and 5, the ladder strap 20, which have their front ends respectively sewed with an ear member 21 inserted therein with a position-limiting rod 22, are respectively fitted in the two elongated slots 16 through the open ends 161, letting the ear members 21 and the position-limiting rods 22 of the two ladder straps 20 respectively restricted and positioned in the first and the second accommodating chamber 131, 132. Thus, the ladder straps 20 can be firmly restrictedly positioned in the elongated slots 16 of the fixing core 10 and clamped by the elastic open end 161 of the elongated slot 16, letting the ladder strap 20 tightly stuck by the inner wall of the elongated slot 16 and prevented form slipping off.

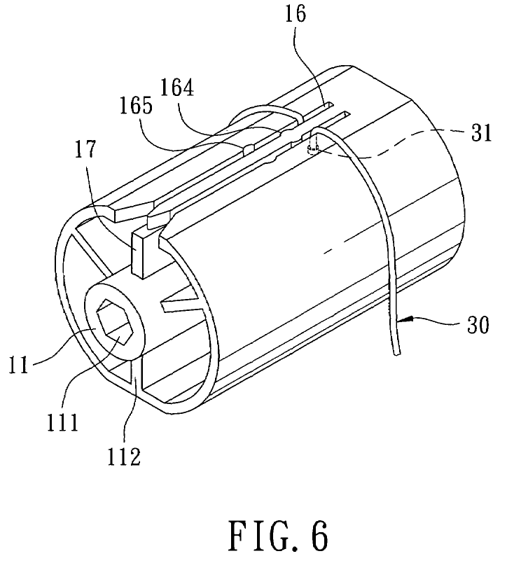

To assemble two ladder cords 30 on the fixing core 10, as shown in FIG. 6, the ladder cord 30, which have their front ends respectively secured with an engage member 31 larger than the width of the elongated slot 16. are respectively inserted in the two elongated slots 16 through the open ends 161, letting the engage members 31 of the two ladder cords 30 respectively restricted and positioned in the first and the second accommodating chamber 131, 132. Subsequently, the ladder cord 30 is moved toward the closed end 162 of the elongated slot 16, passing through the position-limiting projection 164 on the inner wall of the elongated slot 16, and then has the other end inserted out of the elongated slot 16, letting the ladder cord 30 restricted by the position-limiting projection 164 and positioned between the closed end 162 and the position-limiting projection 164 of the elongated slot 16 to prevent the ladder cords 30 from slipping off. Additionally, the ladder cord 30 can also be engaged in the position-limiting notch 165 in the inner wall of the elongated slot 16, equally able to prevent the ladder cords 30 from slipping off.

As can be understood from the above description, this invention has the following advantages.

1. The dual-purpose fixing core is bored with two elongated slots respectively for fitting the ladder straps or the ladder cords of a blind, simple in structure and able to reduce producing cost of fixing cores. In addition, if a blind is to be eliminated or replaced, it is needless to replace the fixing core of the blind, reducing cost and saving time in replacing a blind with a new one.

2. The dual-purpose fixing core has its outer circumferential wall bored with two elongated slots in which ladder straps or ladder cords of a blind can be firmly fitted at the same locations and with the same steps, able to assemble the ladder straps or the ladder cords of a blind quickly and accurately.

3. The two elongated slots of the fixing core respectively have a width large enough for receiving a ladder strap or a ladder cord and are respectively formed with a gradually-expanded open end for facilitating ladder straps or ladder cords of a blind to be fitted in the elongated slot and restrictedly positioned in the accommodating chamber of the fixing core. In addition, the gradually expanded open ends of the elongated slots are elastic and able to clamp the ladder straps, preventing them from slipping off.

4. The ladder cord of a blind can firmly be fixed in the accommodating chamber of the fixing core by means of its engage member secured at one end and also can be restrictedly positioned between the closed end and the position-limiting projection of the elongated slot, able to prevent the ladder cord from slipping off the elongated slot. In addition, the ladder cord can also be engaged in the position-limiting notch in the inner wall of the elongated slot and firmly fixed therein not to slip off the elongated slot.

While the preferred embodiment of the invention has been described above, it will be recognized and understood that various modifications may be made therein and the appended claims are intended to cover all such modifications that may fall within the spirit and scope of the invention.

I claim:

1. A dual-purpose fixing core for a blind employed for fixing the ladder straps or the ladder cords of a blind, said dual-purpose fixing core pivotally assembled with the fixing holder on an upper rail of said blind, said dual-purpose fixing core axially disposed with a core rod at a preset location in the interior, said core rod axially bored with a shaft hole in the central interior, said shaft hole of said core rod inserted therein with a shaft: and,
Characterized by said fixing core having its interior axially formed with an accommodating chamber preset in size, said accommodating chamber of said fixing core formed with at least one opening, said accommodating chamber of said fixing core having its upper circumferential side formed with a top wall, said top wall axially bored with two parallel elongated slots, said two elongated slots respectively having a width smaller than the width of said accommodating chamber but large enough for the ladder strap or the ladder cord of a blind to pass therethrough, said two elongated slots having one end near said opening of said accommodating chamber respectively formed with a gradually-expanded open end, said core rod of said fixing core having its outer circumferential side fixed with an upright plate positioned in said accommodating chamber, said upright plate extending outward diametrically from said outer circumferential side of said core rod to the top wall between said two elongated slots.

2. The dual-purpose fixing core for a blind as claimed in claim 1, wherein each said elongated slot has at least one inner wall provided with at least one position-limiting projection at a preset location.

3. The dual-purpose fixing core for a blind as claimed in claim 1, wherein each said elongated slot has at least one inner wall formed with a position-limiting notch at a preset location.

4. The dual-purpose fixing core for a blind as claimed in claim 1, wherein said accommodating chamber of said fixing core is divided into a first and a second accommodating chamber by said upright plate, said first and said second accommodating chamber having their upper sides respectively aligned to one of said two elongated slots.

5. The dual-purpose fixing core for a blind as claimed in claim 1, wherein said accommodating chamber of said fixing core is disposed inside with ribs preset in number, the included angle of said rib at the opposite sides of said upright plate being within 120 degrees, said ribs extending outward diametrically from the outer circumferential side of said core rod to the circumferential wall of said fixing core.
